(19) United States
(12) Patent Application Publication
(10) Pub. No.: US 2008/0015778 A1
(43) Pub. Date: Jan. 17, 2008

(54) Vehicle motion control device

(76) Inventors: Munenori Matsuura, Tokyo (JP); Katsumi Tomioka, Tokyo (JP)

Correspondence Address: SMITH, GAMBRELL & RUSSELL, 1130 CONNECTICUT AVENUE, N.W., SUITE 1130, WASHINGTON, DC, 20036, US

(21) Appl. No.: 11/822,863

(22) Filed: Jul. 10, 2007

(30) Foreign Application Priority Data
Jul. 12, 2006 (JP) 2006-192011

(51) Int. Cl. G08G 1/16

(52) U.S. Cl. 701/301

(57) ABSTRACT

A vehicle motion control device is provided which can pre-determine an obstacle ahead of the vehicle and adequately reflect the vehicle operator's maneuver and intention in consideration of various travel information throughout an avoidance travel, thereby allowing each vehicle behavior controller to naturally provide adequate control for the vehicle to avoid the obstacle. During the avoidance travel mode, the device allows a vehicle behavior control section to provide necessary control in response to a change in steering operation and vehicle behavior. The avoidance travel mode is released when the steering operation by the vehicle operator causes the end of the avoidance travel to be detected or when the stability of the vehicle behavior is detected after the obstacle has been avoided.

### CROSS REFERENCE TO RELATED APPLICATIONS

The disclosure of Japanese Application No. 2006-192011 filed on Jul. 12, 2006 including the specification, drawings, and abstract is incorporated herein by reference in its entirety.

### BACKGROUND OF THE INVENTION

The present invention relates to a vehicle motion control device which provides pre- to post-avoidance control for the vehicle to adequately avoid an obstacle.

These days, in order to improve the running performance of vehicles, various types of vehicle behavior controllers have been developed and put into practical use. For example, those controllers include a braking force controller for improving the running stability of the vehicle by selectively applying braking force to the wheels during cornering based on the relation between the forces acting on the vehicle during cornering or in a like situation. Also included are a front wheel steering controller for providing an adequate steering angle corrected to the front wheel steering angle based on the vehicle running condition, and a rear wheel steering controller for providing steering control to the rear wheels based on the vehicle running condition. Further included is a right and left driving force distribution controller for providing control to the driving force distributed between the right and left wheels based on the vehicle running condition. Finally, also included is a front and rear driving force distribution controller for providing control, based on the vehicle running condition, to the differential restricting force of the center differential apparatus between the front and rear wheels to distribute torque between the front and rear wheels in a predetermined manner.

Recently, various techniques have been suggested which enable a vehicle to recognize an obstacle ahead of the vehicle (including a preceding vehicle), thereby allowing the vehicle to safely stop or avoid it. For example, according to a technique disclosed in Japanese Patent Application Laid-Open No. 2002-274409, the vehicle recognizes an obstacle and takes into account roadway information, such as road surface friction coefficient and roadway slope, and the relative movement between the vehicle and the obstacle. When it is determined that the vehicle cannot avoid the obstacle only by braking operation, the vehicle behavior control section enters into an avoidance travel mode according to the steering operation and the vehicle behavior.

However, when the vehicle is brought into the avoidance travel mode upon detection of an obstacle, the technique disclosed in the above mentioned publication provides control without reflecting the vehicle operator's intention. That is, the conventional vehicle behavior controller does not have an appropriate control characteristic associated with an avoidance operation of the vehicle operator. This may thus cause the vehicle operator to feel uneasy when he or she is trying to steer around the obstacle. This may also possibly result in the lack of effects of control on the improvement of the turning-round due to delayed timing of intervention in vehicle motion control.

### SUMMARY OF THE INVENTION

The present invention is developed in view of the aforementioned problems. It is therefore an object of the present invention to provide a vehicle motion control device which can pre-determine an obstacle ahead of the vehicle and adequately reflect the vehicle operator's maneuver and intention in consideration of various travel information throughout an avoidance travel, thereby allowing each vehicle behavior controller to naturally provide adequate control for the vehicle to avoid the obstacle.

A vehicle motion control device according to the present invention includes obstacle recognition means for recognizing an obstacle to detect information on the obstacle, and vehicle behavior control means for changing a turning-round performance of a vehicle to control a vehicle behavior.

The vehicle motion control device further includes avoidance operation determination means for determining a state of an avoidance operation for the vehicle performed by a vehicle operator to avoid the obstacle, and avoidance control means for outputting signals to the vehicle behavior control means according to a steering operation of the vehicle operator and a vehicle behavior based thereon. When it is determined by the avoidance operation determination means that the avoidance operation is being performed, the avoidance control means transfers the vehicle behavior control means into an avoidance travel mode thereof based on the outputted signals.

The vehicle motion control device according to the present invention makes it possible to pre-determine an obstacle ahead of the vehicle and adequately reflect the vehicle operator's maneuver and intention in consideration of various travel information throughout an avoidance travel, thereby allowing each vehicle behavior controller to naturally provide adequate control for the vehicle to avoid the obstacle.

### BRIEF DESCRIPTION OF THE DRAWINGS

These and other objects and advantages of the present invention will become clear from the following description with reference to the accompanying drawings, wherein:

FIG. 1 is a schematic explanatory view illustrating the entirety of a vehicle motion control device in a vehicle;

FIG. 2 is a functional block diagram illustrating an avoidance travel control section;

FIG. 3 is a view illustrating a flowchart of an avoidance travel control program;

FIG. 4 is a view showing a flowchart continued from FIG. 3;

FIG. 5 is a view showing a flowchart continued from FIG. 4; and

FIG. 6 is a view showing a flowchart continued from FIG. 3.

### DETAILED DESCRIPTION OF THE PREFERRED EMBODIMENTS

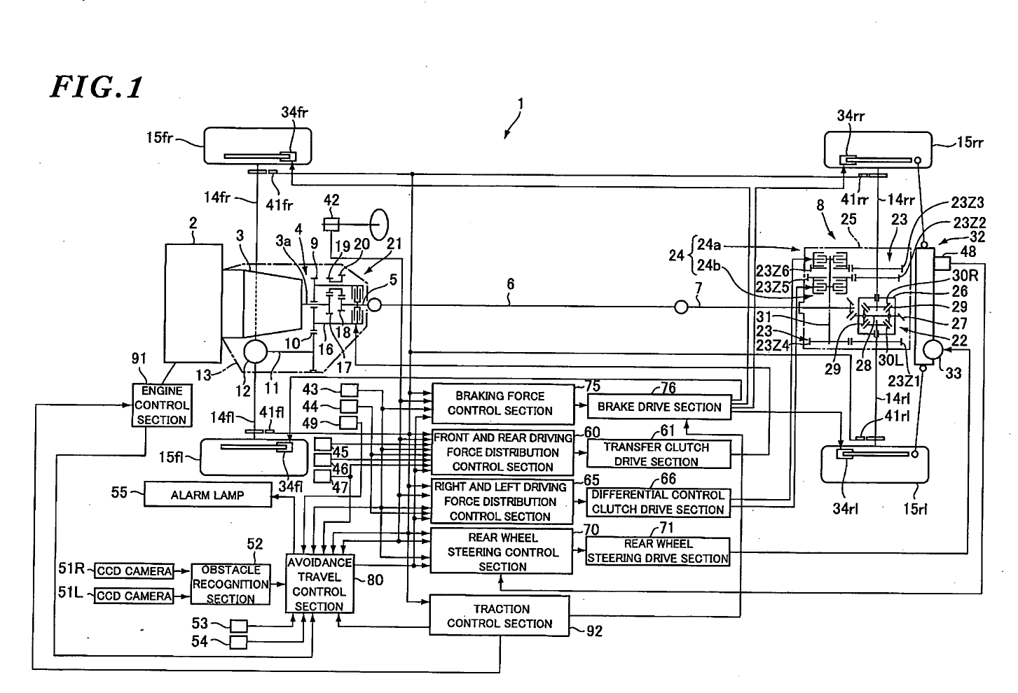

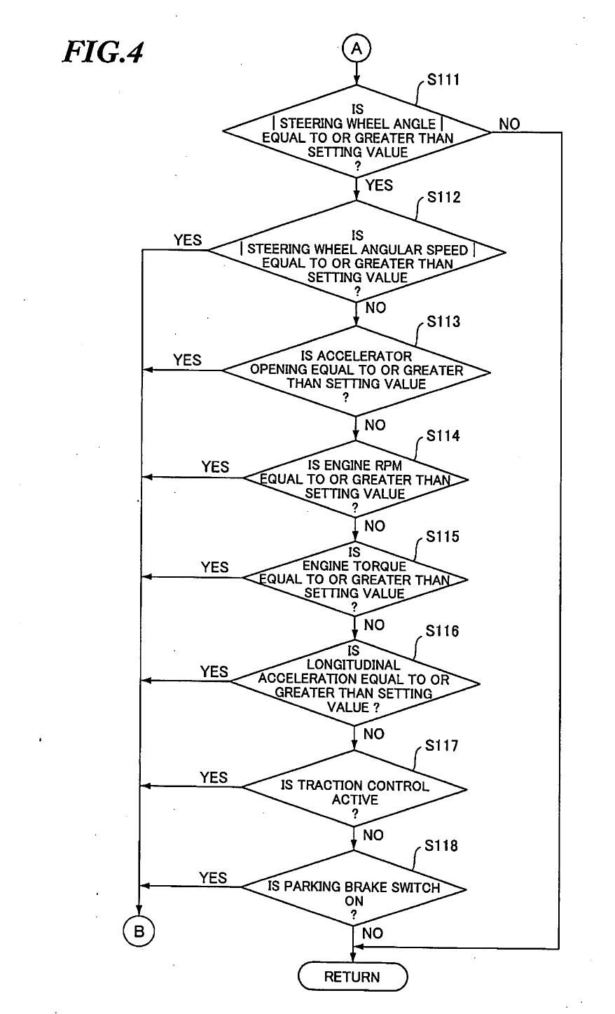

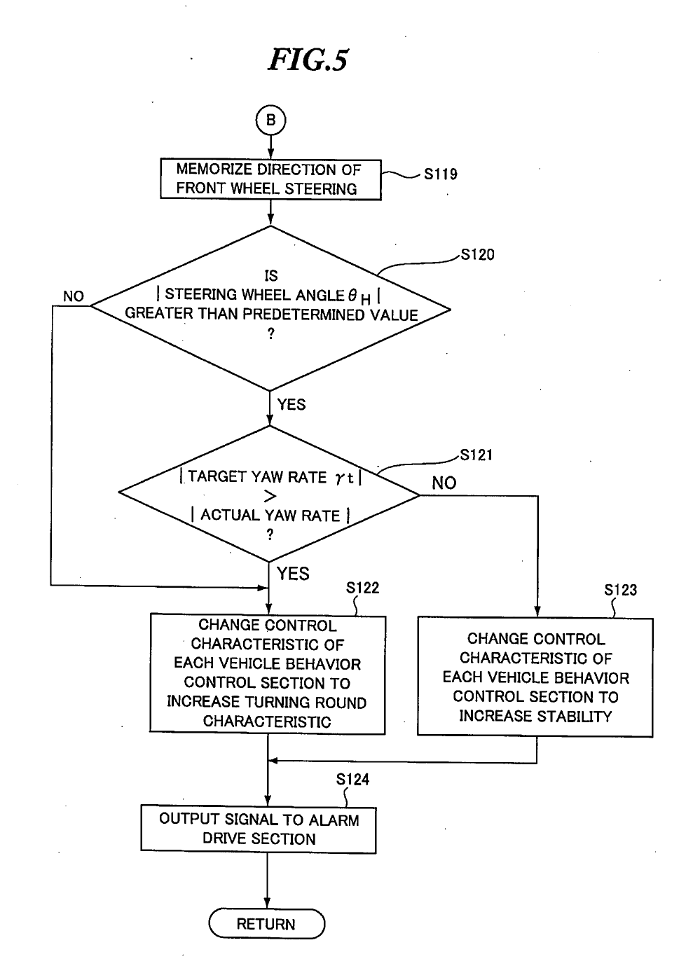

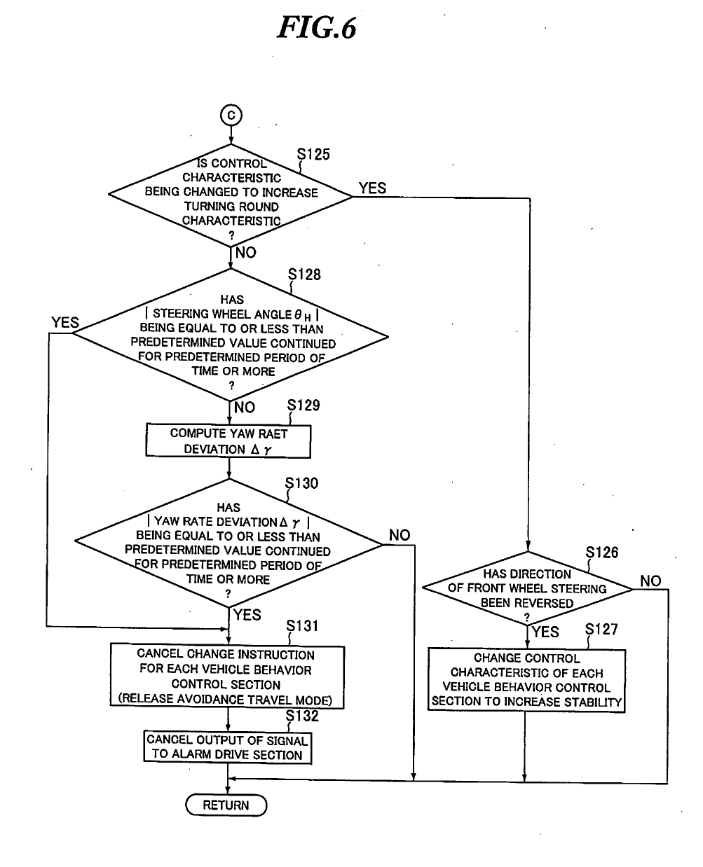

Now, the present invention will be described below in more detail with reference to the accompanying drawings, i.e., FIGS. 1 to 6 showing an embodiment thereof.

With reference to FIG. 1, reference numeral 1 indicates a vehicle, and reference numeral 2 indicates an engine, which is installed in a front portion of the vehicle. The drive force from the engine 2 is transmitted from an automatic transmission 3 (illustrated as including such as a torque converter) behind the engine 2 via a transmission output shaft 3a to a center differential apparatus 4. The center differential apparatus 4 distributes the drive force between the rear wheel side and the front wheel side in a predetermined torque distribution ratio.

The drive force distributed to the rear wheel side from the center differential apparatus 4 is supplied to a rear final drive unit 8 via a rear drive shaft 5, a propeller shaft 6, and a drive pinion 7.

On the other hand, the drive force distributed to the front wheel side from the center differential apparatus 4 is supplied to a front differential apparatus 12 via a transfer driving gear 9, a transfer driven gear 10, and a front drive shaft 11. Here, those such as the automatic transmission 3, the center differential apparatus 4, and the front differential apparatus 12 are integrated within a case 13.

The drive force supplied to the rear final drive unit 8 is transmitted to a left rear wheel 15rl via a left rear wheel drive shaft 14rl and to a right rear wheel 15rr via a right rear wheel drive shaft 14rr. On the other hand, the drive force supplied to the front differential apparatus 12 is transmitted to a left front wheel 15fl via a left front wheel drive shaft 14fl and to a right front wheel 15fr via a right front wheel drive shaft 14fr.

The center differential apparatus 4, which is disposed at a rear portion within the case 13, has the transmission output shaft 3a rotatably inserted therein at the front of a rotatably accommodated carrier 16, and the rear drive shaft 5 rotatably inserted therein at the rear thereof.

The transmission output shaft 3a on the input side rotatably supports, at its rear end portion, a first sun gear 17 having an increased diameter, while the rear drive shaft 5 that provides output to the rear wheels rotatably supports, at its front end portion, a second sun gear 18 having a decreased diameter. The first sun gear 17 and the second sun gear 18 are housed within the carrier 16.

Furthermore, the first sun gear 17 is engaged with a first pinion 19 having a decreased diameter to form a first gear train, while the second sun gear 18 is engaged with a second pinion 20 having an increased diameter to form a second gear train. The first pinion 19 and the second pinion 20 are integrated with each other, so that multiple pairs of (for example, three pairs of) pinions are rotatably supported by the carrier 16. In addition, the carrier 16 has the transfer driving gear 9 coupled to its front end so that output is provided from the carrier 16 to the front wheels.

That is, the center differential apparatus 4 is designed in a composite planetary gear form without a ring gear. In this arrangement, the drive force from the transmission output shaft 3a is transmitted to the first sun gear 17 and then to the rear drive shaft 5 from the second sun gear 18. Output is also provided from the carrier 16 to the front drive shaft 11 via the transfer driving gear 9 and the transfer driven gear 10.

The center differential apparatus 4 of such a composite planetary gear type is provided with a differential function by appropriately setting the number of teeth of the first and second sun gears 17 and 18, and the first and second pinions 19 and 20, which are disposed more than one around the sun gears 17 and 18.

In addition, the pitch radii for the first and second sun gears 17 and 18 engaged with the first and second pinions 19 and 20 can be appropriately set, thereby allowing torque to be allocated as follows. That is, torque can be equally distributed between the front and the rear in a ratio of 50:50 or alternatively unequally distributed so that either the front or the rear is more heavily weighted. This embodiment employs a reference torque distribution between the front and the rear in a ratio of 36:64.

Furthermore, for example, the first and second sun gears 17 and 18 and the first and second pinions 19 and 20 each are a helical gear, and the first gear train and the second gear train have different angles of twist. This allows the thrust loads not to be canceled out but to remain, thereby producing frictional torque between the pinion edge faces. In this arrangement, the resultant force of the separation and tangential loads resulting from the engagement acts upon and thereby causes frictional torque to be produced on the first and second pinions 19 and 20 and the surface of the shaft portion of the carrier 16 rotatably supporting these first and second pinions 19 and 20. This arrangement allows the center differential apparatus 4 according to this embodiment to acquire a differential restricting torque proportional to input torque, and thus the center differential apparatus 4 itself has a differential restricting function.

In addition, between the carrier 16 of the center differential apparatus 4 and the rear drive shaft 5, there is provided a transfer clutch 21 which employs a hydraulic multi-plate clutch and varies drive force to be distributed between the front and rear wheels. Controlling the engagement force of the transfer clutch 21 allows for providing variable control to the torque distribution between the front and rear wheels within the range from a 50:50 ratio for 4WD direct coupling to the torque distribution ratio provided by the center differential apparatus 4.

The transfer clutch 21 is coupled to a transfer clutch drive section 61 which includes an oil hydraulic circuit with a plurality of solenoid valves, so that the hydraulic pressure produced in the transfer clutch drive section 61 causes its release and coupling. A control signal (an output signal for each solenoid valve) for driving the transfer clutch drive section 61 is outputted from a front and rear drive force distribution control section 60, to be discussed later.

On the other hand, the rear final drive unit 8 has a differential function and a driving force distribution function between the right and left wheels. The rear final drive unit 8 mainly includes a bevel geared differential mechanism section 22, a gear mechanism section 23 with a three-gear train, and a clutch mechanism section 24 with two sets of clutches for varying the drive force distribution between the rear right and left wheels. These sections are integrally accommodated in a differential carrier 25.

Furthermore, the drive pinion 7, which is engaged with a final gear 27 that is provided on the outer circumference of a differential case 26 in the differential mechanism section 22, transmits the drive force that is distributed to the rear wheel side from the center differential apparatus 4.

The differential mechanism section 22 is configured to accommodate a differential pinion (bevel gear) 29 and right and left side gears (bevel gears) 30L and 30R engaged therewith in the differential case 26. The differential pinion 29 is rotatably supported by a pinion shaft 28 which is fixed to the differential case 26. These side gears 30L and 30R rotatably support the end portions of right and left rear wheel drive shafts 14rl and 14rr in the differential case 26, respectively.

That is, the differential mechanism section 22 is designed such that the drive pinion 7 rotates to cause the differential case 26 to rotate coaxially with the side gears 30L and 30R, thereby allowing a gear mechanism formed inside the differential case 26 to provide a differential motion between the right and left wheels.

The gear mechanism section 23 is split into the right and left portions to sandwich the differential mechanism section 22. Thus, a first gear 23zl is fixedly attached to the left rear wheel drive shaft 14rl, and a second gear 23z2 and a third gear 23z3 are rotatably supported by the right rear wheel drive shaft 14rr, so that the first, second, and third gears 23zl, 23z2, and 23z3 are disposed coaxially with each other.

These first, second, and third gears 23zl, 23z2, and 23z3 are engaged with fourth, fifth, and sixth gears 23z4, 23z5, and 23z6 which are disposed coaxially with each other. In this arrangement, the fourth gear 23z4 is rotatably attached to the left wheel side end portion of a torque bypass shaft 31 which is disposed coaxially with these fourth, fifth, sixth gears 23z4, 23z5, and 23z6.

A first differential control clutch 24a of the clutch mechanism section 24 for distributing driving force between the right and left wheels is formed on the right wheel side end portion of the torque by pass shaft 31. The torque by pass shaft 31 is freely coupled via the first differential control clutch 24a to the shaft portion of the sixth gear 23z6 that is disposed on the left side of the first differential control clutch 24a (with the torque bypass shaft 31 being on the clutch hub side and the shaft portion of the sixth gear 23z6 being on the clutch drum side).

Furthermore, there is formed a second differential control clutch 24b of the clutch mechanism section 24 on a position of the torque bypass shaft 31 between the differential mechanism section 22 and the fifth gear 23z5. The torque bypass shaft 31 is freely coupled via the second differential control clutch 24b to the shaft portion of the fifth gear 23z5 disposed on the right side of the second differential control clutch 24b (with the torque bypass shaft 31 being on the clutch hub side and the shaft portion of the fifth gear 23z5 being on the clutch drum side).

Furthermore, the numbers of teeth z1, z2, z3, z4, z5, and z6 of the first, second, third, fourth, fifth, and sixth gears 23z1, 23z2, 23z3, 23z4, 23z5, and 23z6 are set, for example, to 82, 78, 86, 46, 50, and 42, respectively. With respect to the gear train of the first and fourth gears 23z1 and 23z4 ((z4/z1)=0.56), the gear train of the second and fifth gears 23z2 and 23z5 ((z5/z2)=0.64) is used for acceleration whereas the gear train of the third and sixth gears 23z3 and 23z6 ((z6/z3)=0.49) is used for deceleration.

Accordingly, without operative coupling with both the first and second differential control clutches 24a and 24b, the drive force from the drive pinion 6 is transmitted as it is via the differential mechanism section 22 and equally distributed to the right and left rear wheel drive shafts 14rl and 14rr. However, operative coupling with the first differential control clutch 24a causes part of the drive force distributed to the right rear wheel drive shaft 14rr to be transmitted back to the differential case 26 sequentially via the third gear 23z3, the sixth gear 23z6, the first differential control clutch 24a, the torque bypass shaft 31, the fourth gear 23z4, and the first gear 23zl. As a result, a larger portion of the torque is distributed to the left rear wheel 15rl, and the right cornering characteristic of the vehicle is improved for a typical roadway surface μ.

Conversely, operative coupling with the second differential control clutch 24b causes part of the drive force transmitted to the differential case 26 from the drive pinion 6 to be bypassed to the right rear wheel drive shaft 14rr sequentially via the first gear 23z1, the fourth gear 23z4, the torque bypass shaft 31, the second differential control clutch 24b, the fifth gear 23z5, and the second gear 23z2. Thus, a larger portion of the torque is distributed to the right rear wheel 15rr, and the left cornering characteristic of the vehicle is improved for a typical roadway surface μ.

The first and second differential control clutches 24a and 24b are coupled to a differential control clutch drive section 66 which includes an oil hydraulic circuit with a plurality of solenoid valves, so that the hydraulic pressure produced in the differential control clutch drive section 66 causes their release and coupling. A control signal (an output signal for each solenoid valve) for driving the differential control clutch drive section 66 is outputted from a right and left drive force distribution control section 65, to be discussed later.

On the other hand, reference numeral 32 indicates a rear wheel steering portion of the vehicle 1. The rear wheel steering portion 32 is provided with a rear wheel steering motor 33 driven by a rear wheel steering drive section 71 which is controlled by a rear wheel steering control section 70, to be discussed later. The driving force provided by the rear wheel steering motor 33 is transmitted via a worm to worm-wheel link mechanism to rotationally drive the left rear wheel 15rl and the right rear wheel.

In addition, reference numeral 76 indicates a brake drive section of the vehicle. The brake drive section 76 is coupled with a master cylinder (not shown) which is coupled to the brake pedal operated by the vehicle operator. Pressing the brake pedal by the vehicle operator causes the master cylinder to introduce a brake pressure through the brake drive section 76 into each wheel cylinder (a left front wheel cylinder 34fl, a right front wheel cylinder 34fr, a left rear wheel cylinder 34rl, and a right rear wheel cylinder 34rr) of the four wheels 15fl, 15fr, 15rl, and 15rr, thereby allowing the brakes to be applied to the four wheels.

The brake drive section 76 is a hydraulic unit which includes a pressurization source, a pressure reducing valve, a pressure increasing valve or the like. The brake drive section 76 is not only adapted to the braking operation by the vehicle operator but also to freely introduce a brake pressure independently to each of the wheel cylinders 34fl, 34fr, 34rl, and 34rr in accordance with an input signal from a braking force control section 75 and a traction control section 92, to be discussed later.

The front and rear drive force distribution control section 60, the right and left drive force distribution control section 65, the rear wheel steering control section 70, and the braking force control section 75 are each provided as vehicle behavior control means. The vehicle 1 includes an avoidance travel control section 80 which outputs a signal to each of the control portions 60, 65, 70, and 75.

Note that in the figure, as is well known, an engine control section 91 provides general control to the engine 2 including fuel injection control and ignition timing control. On the other hand, the traction control section 92 is configured to detect the slip ratio of each wheel based on the wheel speed from each of wheel speed sensors 41fl, 41fr, 41rl, and 41rr, to be discussed later. When the slip ratio is equal to or greater than a pre-set slip ratio determination value, the traction control section 92 outputs a predetermined control signal to the brake drive section 76 or the engine control section 91 to automatically apply the brakes or decrease the torque from the engine 2, thereby preventing idling of the wheels.

The vehicle 1 is provided with sensors and switches as vehicle information detection means for detecting the running conditions of the vehicle. That is, the wheel speeds of each of the wheels 15fl, 15fr, 15rl, and 15rr are detected by the wheel speed sensors 41fl, 41fr, 41rl, and 41rr, respectively, and computed in a predetermined manner as a vehicle speed V. The vehicle speed V is then supplied to the front and rear drive force distribution control section 60, the right and left drive force distribution control section 65, the rear wheel steering control section 70, the braking force control section 75, and the avoidance travel control section 80. In addition, a steering wheel angle θH detected by a steering wheel angle sensor 42 and a yaw rate γ detected by a yaw rate sensor 43 are supplied to the front and rear drive force distribution control section 60, the right and left drive force distribution control section 65, the rear wheel steering control section 70, the braking force control section 75, and the avoidance travel control section 80. Furthermore, a lateral acceleration Gy detected by a lateral acceleration sensor 44 is supplied to the front and rear drive force distribution control section 60 and the right and left drive force distribution control section 65. In addition, a throttle opening θth detected by a throttle opening sensor 45 and a gear position detected by an inhibitor switch 46 are supplied to the front and rear drive force distribution control section 60. Furthermore, an engine speed Ne detected by an engine speed sensor 47 is supplied to the front and rear drive force distribution control section 60 and the avoidance travel control section 80. In addition, a rear wheel steering angle δr detected by a rear wheel steering angle sensor 48 is supplied to the rear wheel steering control section 70, and a longitudinal acceleration GX detected by a longitudinal acceleration sensor 49 is supplied to the avoidance travel control section 80. An accelerator opening θac detected by an accelerator pedal sensor 53 is also supplied to the avoidance travel control section 80. The ON or OFF state of the parking brake detected by a parking brake switch 54 is also supplied to the avoidance travel control section 80. The avoidance travel control section 80 also receives an engine (output) torque Te from the engine control section 91 and a traction control ON/OFF signal from the traction control section 92. In addition, in the vehicle 1, an alarm lamp 55 that is lit by the avoidance travel control section 80 during an avoidance travel is provided within the instrument panel.

In addition, the vehicle 1 includes a stereo optical assembly which has, for example, a set of CCD cameras (a left camera 51L and a right camera 51R) that employ a solid-state imaging device such as a charge-coupled device (CCD). The stereo optical assembly is thus designed such that the left and right CCD cameras 51L and 51R are each attached to the front ceiling in the passenger room with a certain spacing therebetween, so that the image of an object outside the vehicle can be captured stereoscopically from the different viewpoints.

Those image signals outputted from the CCD cameras 51L and 51R are supplied to an obstacle recognition section 52 to compute a three-dimensional distance data based on the parallax for the same object. Then, the distance data is processed to recognize the shape of a roadway and a plurality of stereoscopic objects, thereby detecting an obstacle on the travel path such as another vehicle running ahead of the vehicle. That is, in the embodiment of the present invention, the CCD cameras 51L and 51R and the obstacle recognition section 52 form obstacle recognition means for recognizing an obstacle on the travel path to detect obstacle information.

The obstacle recognition section 52 searches each minute region of the two stereoscopic images, which have been captured by the CCD cameras 51L and 51R, for those portions in which the same object has been shot. Then, based on the amount of displacement determined between the corresponding positions, the distance to the object is calculated to store the resulting distance data (distance image). The distance data is then processed to recognize the shape of the roadway and a plurality of stereoscopic objects, thereby detecting the obstacle.

More specifically, in a roadway detection process performed by the obstacle recognition section 52, only white lines on an actual roadway are separately extracted using three-dimensional positional information derived from the stored distance image. Then, road model parameters stored are modified or changed to correspond with the actual shape of the road, thereby recognizing the shape of the roadway and the own traffic lane.

In addition, in an obstacle or object detection process performed by the obstacle recognition section 52, a distance image is partitioned at predetermined intervals in a grid pattern, and in each region, only such data as on a stereoscopic object that is likely to be an obstacle to the travel is selected to calculate its detected distance. Then, if the difference between the resulting distance and the detected distance to the object in an adjacent region is less than or equal to a setting value, the object is determined to be the same one. On the other hand, if the difference is greater than the setting value, the object is determined to be a different one, and then the outline image of the detected object (obstacle) is extracted. Note that these processes mentioned here for generating a distance image and detecting the shape of roadways or the object based on the distance image are discussed in detail in Japanese Patent Applications Laid-Open No. Hei 5-265547 and No. Hei 8-45000, which were previously applied by the present applicant.

Then, the data on the obstacle detected by the obstacle recognition section 52 (such as the distance Ls to the obstacle (another vehicle running ahead), the speed Vs of the obstacle (the vehicle running ahead), the deceleration as of the obstacle (the vehicle running ahead)) is supplied to the avoidance travel control section 80.

A description will now be made to each control portion for controlling the vehicle behavior of the vehicle 1.

The front and rear drive force distribution control section 60 employs, for example, a method that the present applicant has disclosed in Japanese Patent Application Laid-Open No. Hei 8-2274. That is, using the vehicle speed V, the steering wheel angle θH, and the actual yaw rate γ, based on the equation of lateral motion of the vehicle, the cornering power of the front and rear wheels is extended to a non-linear region for estimation. A roadway friction coefficient μ is estimated according to the roadway surface conditions based on the ratio of the estimated front and rear wheel cornering power to the equivalent cornering power of the front and rear wheels on a high-μ road. Then, a pre-set map is referenced in response to the roadway friction coefficient μ to determine a base clutch torque VTDout0. A correction is then provided to the base clutch torque VTDout0 in accordance with an input torque Ti (computed from the engine speed Ne and the gear ratio i) supplied to the center differential apparatus 4, the throttle opening θth, the actual yaw rate γ, the deviation between the target yaw rate γt, which was computed from the steering wheel angle θH and the vehicle speed V, and the actual yaw rate γ (a yaw rate deviation Δγ=γ−γt), and the lateral acceleration Gy. Thus computed is a control output torque VTDout on which a fundamental clutch engagement force FOtb for the front and rear wheel driving force distribution relies. Furthermore, the control output torque VTDout is given a correction using a steering wheel angle θ and thus defined as a steering wheel angle sensitive clutch torque or the fundamental clutch engagement force FOtb on the transfer clutch 21. A predetermined signal corresponding thereto is outputted to the transfer clutch drive section 61 to allow the hydraulic clutch pressure to actuate the transfer clutch 21 so as to impart a differential restricting force to the center differential apparatus 4, thereby providing driving force distribution control between the front and rear wheels.

Note that the correction based on the yaw rate deviation Δγ is intended to add or subtract a clutch torque to or from the base clutch torque VTDout0 in accordance with the deviation between the target yaw rate γt and the actual yaw rate γ, which is expected to occur during cornering, in order to prevent the oversteer tendency or the understeer tendency of the vehicle.

For example, it may be expected during cornering that the target yaw rate γt (absolute value) is higher and the actual yaw rate γ (absolute value) is lower, so that the vehicle tends to understeer. In this case, a correction for reducing the clutch torque allows more drive force to be distributed to the rear wheels than to the front wheels, thereby improving the turning-round.

In contrast to this, it may also be expected during cornering that the target yaw rate γt (absolute value) is lower and the actual yaw rate γ (absolute value) is higher, so that the vehicle tends to oversteer. In this case, a correction for increasing the clutch torque allows equal drive force to be distributed between the rear and front wheels, thereby improving the stability.

In addition, the front and rear drive force distribution control section 60 is configured to receive a control signal for improving the turning-round or for improving the stability from the avoidance travel control section 80. When the front and rear drive force distribution control section 60 receives a control signal for improving the turning-round, a correction is provided so that the computed target yaw rate γt (absolute value) is multiplied by a coefficient greater than 1 to make the target yaw rate γt (absolute value) greater than usual. The correction to decrease the clutch torque causes more drive force to be distributed to the rear wheels than to the front wheels, thereby improving the turning-round. Conversely, when the front and rear drive force distribution control section 60 receives a control signal for improving the stability, a correction is provided so that the computed target yaw rate γt (absolute value) is multiplied by a coefficient less than 1 to make the target yaw rate γt (absolute value) smaller than usual. The correction to increase the clutch torque causes the equal drive force to be distributed to the rear and front wheels, there by improving the stability.

In addition, the right and left drive force distribution control section 65 computes the clutch torque in accordance with the tire loads on the right and left sides of the vehicle, for example, based on the vehicle speed V, the steering wheel angle θH, and the lateral acceleration Gy. The clutch torque is corrected by the deviation between the target yaw rate γt, which has been computed from the steering wheel angle θH and the vehicle speed V, and the actual yaw rate γ. Then, to eventually generate this clutch torque, the first differential control clutch 24a or the second differential control clutch 24b is actuated to provide control for allocating driving force between the right and left wheels.

Note that the correction based on the yaw rate deviation Δγ made by the right and left drive force distribution control section 65 is also intended to increase or decrease the clutch torque in accordance with the deviation between the target yaw rate γt and the actual yaw rate y, which is expected to occur during cornering, in order to prevent the oversteer tendency or the understeer tendency of the vehicle.

For example, it may be expected during cornering that the target yaw rate γt (absolute value) is higher and the actual yaw rate γ (absolute value) is lower, so that the vehicle tends to understeer. In this case, a correction for allowing an increased drive force to be distributed to the outer cornering wheels is made, thereby improving the turning-round.

In contrast to this, it may also be expected during cornering that the target yaw rate γt (absolute value) is lower and the actual yaw rate y (absolute value) is higher, so that the vehicle tends to oversteer. In this case, a correction for preventing an increase in the drive force to be distributed to the outer cornering wheels is made, thereby improving the stability.

In addition, the right and left drive force distribution control section 65 is configured to receive a control signal for improving the turning-round or for improving the stability from the avoidance travel control section 80. When the right and left drive force distribution control section 65 receives a control signal for improving the turning-round, a correction is provided so that the computed target yaw rate γt (absolute value) is multiplied by a coefficient greater than 1 to make the target yaw rate γt (absolute value) greater than usual. The correction causes a greater drive force to be distributed to the outer cornering wheels, thereby improving the turning-round. Conversely, when the right and left drive force distribution control section 65 receives a control signal for improving the stability, a correction is provided so that the computed target yaw rate γt (absolute value) is multiplied by a coefficient less than 1 to make the target yaw rate γt (absolute value) smaller than usual. The correction prevents an increase in the drive force to be distributed to the outer cornering wheels, thereby improving the stability.

For example, using the vehicle speed V, the steering wheel angle θf, and the yaw rate γ, the rear wheel steering control section 70 pre-computes a target rear wheel steering angle δr′ in accordance with predetermined control rules to compare it with the current rear wheel steering angle δr, thereby setting a required amount of rear wheel steering. A signal corresponding to the amount of rear wheel steering is outputted to the rear wheel steering drive section 71 to drive the rear wheel steering motor 33. Then, in response to a control signal from the avoidance travel control section 80, a correction is made in a predetermined manner to increase the amount of in-phase steering of the rear wheel steering angle for the front wheel steering angle and the yaw rate.

The control provided by the rear wheel steering control section 70 will be described in more detail. The control rules defined in the rear wheel steering control section 70 employ, for example, the well-known “opposite phase steering wheel angle+ in-phase yaw rate control rules” as the basic control rules in the embodiment of the present invention, and are given by Equation (1) below.

δr′=−kδ0·fl·(θH/N)+kδ0·f2·γ (1)

where kδ0 is the steering wheel angle sensitive gain, kγ0 is the yaw rate sensitive gain, and N is the steering gear ratio.

The yaw rate sensitive gain kγ0 is a coefficient for defining the amount of steering of the rear wheels to reduce the yaw rate γ. In addition, the steering wheel angle sensitive gain kδ0 is a coefficient for defining the amount of steering of the rear wheels to provide the steering turning-round.

That is, the yaw rate sensitive gain kγ0 is given to steer the rear wheels in phase with the yaw rate γ, so that as the yaw rate sensitive gain kγ0 increases, the vehicle tends to travel diagonally without cornering, thus preventing the occurrence of the yaw rate γ. In other words, the vehicle will have a decreased turning-round and an improved stability. Thus, the yaw rate sensitive gain kγ0 can be regarded as a coefficient that shows what amount of steering can be provided to the rear wheels for the yaw rate γ occurred in order to prevent the occurrence of the yaw rate γ.

However, only the yaw rate sensitive gain kγ0 is not enough for the vehicle to be capable of cornering. To prevent this, the steering wheel angle sensitive gain kδ0 is defined. That is, the rear wheels are steered in opposite phase with the steering wheel angle θH, thereby improving the turning-round of the vehicle. The term “steering wheel angle sensitive gain kδ0” is set to be greater for the steering wheel angle θH, thereby allowing cornering of the vehicle. However, bringing the steering back to the neutral state leaves the control rules only with the term of the yaw rate sensitive gain kγ0. Thus, after the cornering, the rear wheels are steered to eliminate the yaw rate γ (to eliminate the yawing of the vehicle).

In addition, since the steering wheel angle sensitive gain kδ0 is calculated based on the cornering power of the front wheels and the rear wheels, the value of the steering wheel angle sensitive gain kδ0 does not vary at a certain vehicle speed or greater. However, when the vehicle speed is at nearly zero, the steering wheel angle sensitive gain kδ0 is set at a small value in order to prevent steering of the rear wheels when the vehicle is at a standstill.

According to the embodiment of the present invention, the steering wheel angle sensitive gain kδ0 and the yaw rate sensitive gain kγ0, which are set as described above, are provided with a correction in response to the control signal being supplied from the avoidance travel control section 80. That is, the correction can be provided by multiplying the steering wheel angle sensitive gain kδ0 by a rear wheel steering angle correction value f1. The correction can also be provided by multiplying the yaw rate sensitive gain kγ0 by a rear wheel steering angle correction value f2.

That is, to improve the turning-round, a correction is made such that the steering wheel angle sensitive gain kδ0 is multiplied by the rear wheel steering angle correction value f1 greater than 1 to increase its absolute value. This causes the rear wheels to be steered in opposite phase with the steering wheel angle θH with respect to the normal operation.

In contrast to this, to improve the stability, a correction is made such that the steering wheel angle sensitive gain kδ0 is multiplied by the rear wheel steering angle correction value f1 less than 1 to decrease its absolute value. This decreases the steering of the rear wheels in opposite phase with the steering wheel angle θH with respect to the normal operation, thereby preventing the turning-round of the vehicle from being increased.

In addition, to improve the turning-round, a correction is provided such that the yaw rate sensitive gain kγ0 is multiplied by the rear wheel steering angle correction value f2 less than 1 and thus made smaller than usual, thereby allowing a small correction to be provided to the rear wheels in phase with the yaw rate y.

In contrast to this, to improve the stability, a correction is made such that the yaw rate sensitive gain kγ0 is multiplied by the rear wheel steering angle correction value f2 greater than 1 and thus made greater than usual. This increases the steering of the rear wheels in phase with the yaw rate y, thereby preventing the turning-round of the vehicle from being increased.

Note that depending on the vehicle, such an effect can be naturally obtained by providing a correction to only either the steering wheel angle sensitive gain kδ0 or the yaw rate sensitive gain kγ0.

For example, basically, the braking force control section 75 determines the wheel to be braked based on the target yaw rate γt derived from the vehicle speed V and the steering wheel angle θH, and the actual yaw rate y, and then adds the computed braking force thereto, thereby producing the optimum yaw moment for the vehicle. More specifically, if the target yaw rate γt (absolute value) is higher and the actual yaw rate γ (absolute value) is lower, and the vehicle tends to understeer, then the brakes are applied to the inner cornering rear wheel to increase the turning-round of the vehicle. In contrast to this, if the target yaw rate γt (absolute value) is lower and the actual yaw rate γ (absolute value) is higher, and the vehicle tends to oversteer, then the brakes are applied to the outer cornering front wheel to improve the stability of the vehicle.

In addition, the braking force control section 75 is configured to receive a control signal for improving the turning-round or for improving the stability from the avoidance travel control section 80. When the braking force control section 75 receives a control signal for improving the turning-round, a correction is provided so that the computed target yaw rate γt (absolute value) is multiplied by a coefficient greater than 1 to make the target yaw rate γt (absolute value) greater than usual. Conversely, when the braking force control section 75 receives a control signal for improving the stability, a correction is provided so that the computed target yaw rate γt (absolute value) is multiplied by a coefficient less than 1 to make the target yaw rate γt (absolute value) smaller than usual.

Now, the avoidance travel control section 80 will be described. The avoidance travel control section 80 is supplied with each running and operation information on the vehicle 1 such as the vehicle speed V, the steering wheel angle θH, the yaw rate γ, the longitudinal acceleration GX, the accelerator opening θac, the engine speed Ne, the ON/OFF state of the parking brake, the engine torque Te, and a traction control ON/OFF state. The avoidance travel control section 80 is also supplied from the obstacle recognition section 52 with obstacle (a vehicle running ahead) information (such as the distance Ls to the obstacle (the vehicle running ahead), the speed Vs of the obstacle (the vehicle running ahead), and the deceleration αs of the obstacle (the vehicle running ahead)).

Then, based on the obstacle information, the vehicle information, and the roadway information to be estimated by calculation, it is determined whether the vehicle 1 can avoid the obstacle only by the braking operation of the vehicle 1. If only the braking operation is not enough to avoid the obstacle and the vehicle 1 is being maneuvered to avoid the obstacle, the vehicle 1 changes to an avoidance travel mode according to the steering operation and the vehicle behavior. In this mode, outputted is a signal for each of the vehicle behavior control portions 60, 65, 70, and 75 to change the control characteristic to increase the turning-round or to improve the stability. In addition, during the avoidance travel mode, the signal for changing the control characteristic in the avoidance travel mode is variably controlled according to the steering operation and the vehicle behavior.

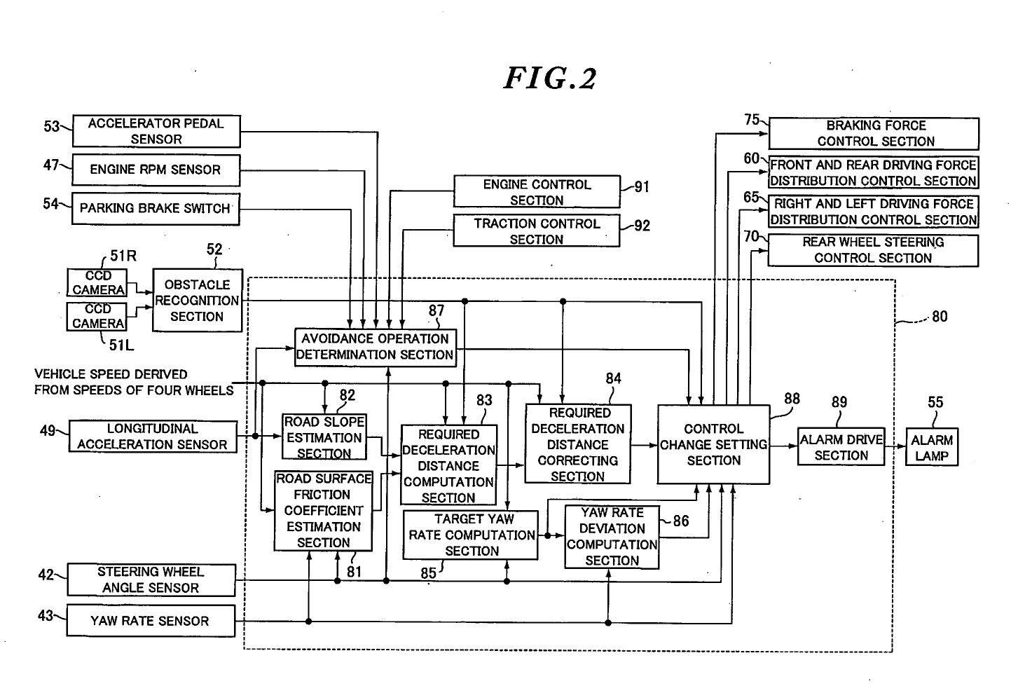

As shown in FIG. 2, the avoidance travel control section 80 is mainly made up of a roadway friction coefficient estimation section 81, a roadway slope estimation section 82, a required deceleration distance computation section 83, a required deceleration distance correcting section 84, a target yaw rate computation section 85, a yaw rate deviation computation section 86, an avoidance operation determination section 87, a control change setting section 88, and an alarm drive section 89.

As described above, the roadway friction coefficient estimation section 81, which is supplied with the vehicle speed V, the steering wheel angle θH, and the actual yaw rate y, extends the cornering power of the front and rear wheels to a non-linear region for estimation based on the equation of lateral motion of the vehicle. The roadway friction coefficient μ is estimated according to the roadway surface conditions based on the ratio of the estimated front and rear wheel cornering power to the equivalent cornering power of the front and rear wheels on a high-μ road. Then, the estimated roadway friction coefficient μ is outputted to the required deceleration distance computation section 83.

The roadway slope estimation section 82 is supplied with the vehicle speed V and the longitudinal acceleration GX to calculate the rate of change of the vehicle speed V (m/s²) at preset time intervals. Using the rate of change in vehicle speed (m/s²) and the longitudinal acceleration GX, a roadway slope SL (%) is computed by Equation (2) below, and then outputted to the required deceleration distance computation section 83.

The roadway slope SL=(the longitudinal acceleration GX−the rate of change in vehicle speed/g)·100 (2)

where the gravitational acceleration is g (m/S²) and the uphill roadway slope is indicated by (+).

Note that, as shown in Equation (3) below, the roadway slope SL may also be computed using the engine output torque (N-m), the torque ratio of the torque converter (for the automatic transmission vehicle), the transmission gear ratio, the final gear ratio, the radius of the tires (m), the running resistance (N), the mass of the vehicle (kg), the rate of change in vehicle speed (m/s²), and the gravitational acceleration g (m/s²).

The roadway slope SL=tan(sin^{31 1}((((the engine output torque·the torque ratio of the torque converter·the transmission gear ratio·the final gear ratio/the radius of the tires)−the running resistance)/the mass of the vehicle−the rate of change in vehicle speed)/g))·100) is approximately equal to ((((the engine output torque the torque ratio of the torque converter·the transmission gear ratio·the final gear ratio/the radius of the tires)−the running resistance)/the mass of the vehicle−the rate of change in vehicle speed)/g))·100 (3)

The required deceleration distance computation section 83 is supplied with the vehicle speed V, the obstacle (a vehicle running ahead) speed Vs, and the obstacle (the vehicle running ahead) deceleration as (m/s²) as well as with the roadway friction coefficient μ from the roadway friction coefficient estimation section 81 and the roadway slope SL from the roadway slope estimation section 82. The required deceleration distance computation section 83 takes the relative motion between the vehicle 1 and the obstacle (the vehicle running ahead) into consideration to compute the minimum distance (the required deceleration distance) LGB which is just enough to avoid the obstacle (the vehicle running ahead) only by the braking operation of the vehicle 1. The required deceleration distance LGB is computed by Equation (4) below, and then outputted to the required deceleration distance correcting section 84.

The required deceleration distance LGB=(½)·(V−Vs)²/((μ−(SL/100))·g−αs) (4)

The required deceleration distance correcting section 84 is supplied with the vehicle speed V, the obstacle (a vehicle running ahead) speed Vs, and the obstacle (the vehicle running ahead) deceleration as, to compute the deceleration α(m/s²) of the vehicle from the vehicle speed V. Then, as shown in Equation (5) below, the required deceleration distance correcting section 84 takes a delay in the vehicle operator's braking operation into account to provide a correction to the required deceleration distance LGB. Assuming that the pre-set operator's delay time in the operation is Ttd(s),

The required deceleration distance LGB=LGB+(V−Vs)·Ttd+(½)·(αs−α)·Ttd² (5)

### Then, the required deceleration distance LGB which has been corrected at the required deceleration distance correcting section 84 is outputted to the control change setting section 88.

The target yaw rate computation section 85 is supplied with the vehicle speed V and the steering wheel angle θH to compute the target yaw rate γt. The target yaw rate γt is computed by Equation (6) below generally in the same manner as in the other vehicle behavior control sections (for example, the front and rear drive force distribution control section 60, the right and left drive force distribution control section 65, and the braking force control section 75).

The target yaw rate γt=1/(1+T·S)·γt0 (6)

where S is the Laplace operator, T is the primary delay time constant, and γt0 is the target yaw rate steady value. The primary delay time constant T is given by Equation (7) below.

The primary delay time constant T=(m·Lf·V)/(2·L·Kr) (7)

where m is the mass of the vehicle, L is the wheel base, Lf is the distance between the front shaft and the center of gravity, and Kr is the rear equivalent cornering power.

In addition, the target yaw rate steady value γt0 is given by Equation (8) below.

The target yaw rate steady value γt0=Gγδ·(θH/n) (8)

where n is the steering gear ratio and Gγδ is the yaw rate gain. Here, the yaw rate gain Gγδ is determined by Equation (9) below.

The yaw rate gain Gγδ=1/(1+A·V²)·(V/L) (9)

where “A” is the stability factor that is determined by various specifications of the vehicle, and is computed by Equation (10) below.

The stability factor A=−(m/(2L²))·(Lf·Kf−Lr·Kr)/(Kf·Kr) (10)

### In Equation (10) above, Lr is the distance between the rear shaft and the center of gravity, and Kf is the front equivalent cornering power.

The yaw rate deviation computation section 86 is supplied with the actual yaw rate γfrom the yaw rate sensor 43 and the target yaw rate γt from the target yaw rate computation section 85, and computes the yaw rate deviation Δγ by Equation (11) for output to the control change setting section 88.

The yaw rate deviation Δγ=γ−γt (11)

The avoidance operation determination section 87 is supplied with the steering wheel angle θH, the longitudinal acceleration GX, the engine speed Ne, the accelerator opening θac, the engine torque Te, the ON/OFF state of the parking switch, and the traction control ON/OFF state.

Then, the avoidance operation determination section 87 determines that the vehicle operator is performing an avoidance operation if any one of the following conditions is met: if the absolute value of the steering wheel angle θH is a pre-set threshold value or greater, and any one of the absolute value of the steering wheel angular speed (dθH/dt), the longitudinal acceleration GX, the engine speed Ne, the accelerator opening θac, and the engine torque Te is equal to or greater than a correspondingly pre-set threshold value; if the traction control is in an ON state; or if the parking switch is in an ON state.

On the other hand, the avoidance operation determination section 87 determines that the vehicle operator is not performing an avoidance operation if any one of the following conditions is not satisfied: if the absolute value of the steering wheel angle EH is less than the pre-set threshold value; or if all of the absolute value of the steering wheel angular speed (dθH/dt), the longitudinal acceleration GX, the engine speed Ne, the accelerator opening, θac, and the engine torque Te are less than the respectively pre-set threshold values, with the traction control being in an OFF state and the parking switch being in an OFF state.

Note that in the embodiment of the present invention, whether an avoidance operation is being performed by the vehicle operator is determined using the steering wheel angle EH serving as a parameter to determine a turning-round operation, and other seven parameters. However, depending on the vehicle of interest, only the steering wheel angle EH or a combination of any one(s) of the aforementioned parameters may be employed to determine whether the vehicle operator is performing an avoidance operation.

In addition, the embodiment of the present invention employs the value of the steering wheel angle θH especially as a parameter for determining the turning-round operation by the vehicle operator. Accordingly, instead of the steering wheel angle θH, for example, the actual yaw rate y may also be employed as a parameter for determining the turning-round operation by the vehicle operator. In this case, it is determined that the vehicle operator is performing an avoidance operation, if any one of the following conditions is satisfied: if the absolute value of the actual yaw rate γ is a pre-set threshold value or greater, and any one of the absolute value of the yaw angular acceleration (dγ/dt), the longitudinal acceleration GX, the engine speed Ne, the accelerator opening θac, and the engine torque Te is equal to or greater than the correspondingly pre-set threshold value; if the traction control is in an ON state; or if the parking switch is in an ON state.

The lateral acceleration Gy may also be employed as a parameter for determining the turning-round operation by the vehicle operator. In this case, it is determined that the vehicle operator is performing an avoidance operation, if any one of the following conditions is satisfied: if the lateral acceleration Gy is a pre-set threshold value or greater, and any one of a lateral speed (∫(Gy)dt), the longitudinal acceleration GX, the engine speed Ne, the accelerator opening θac, and the engine torque Te is equal to or greater than the correspondingly pre-set threshold value; if the traction control is in an ON state; or if the parking switch is in an ON state.

It is also possible to employ a skid angle β (which is calculated using a plurality of sensor values) as a parameter for determining the turning-round operation by the vehicle operator. In this case, it is determined that the vehicle operator is performing an avoidance operation, if any one of the following conditions is satisfied: if the skid angle β has a pre-set threshold value or greater and any one of a skid angular velocity (dβ/dt), the longitudinal acceleration GX, the engine speed Ne, the accelerator opening θac, and the engine torque Te is equal to or greater than the correspondingly pre-set threshold value; if the traction control is in an ON state; or if the parking switch is in an ON state.

It is also possible to employ a vehicle travel vector (which is defined according to the direction of the vehicle and a change in it) as a parameter for determining the turning-round operation by the vehicle operator. In this case, it is determined that the vehicle operator is performing an avoidance operation, if any one of the following conditions is satisfied: if the vehicle travel vector has a pre-set threshold value or greater, and any one of the differentiated value of the vehicle travel vector, the longitudinal acceleration GX, the engine speed Ne, the accelerator opening θac, and the engine torque Te is equal to or greater than the correspondingly pre-set threshold value; if the traction control is in an ON state; or if the parking switch is in an ON state.

It may be also possible to determine that the vehicle operator is performing an avoidance operation, if each of the amounts of change in the engine speed Ne, the accelerator opening θac, and the engine torque Te, which are mentioned above, is a correspondingly pre-set threshold value or greater.

That is, in the embodiment of the present invention, the avoidance operation determination section 87 is provided as avoidance operation determination means.

The control change setting section 88 is supplied with the steering wheel angle θH, the actual yaw rate y, and the distance Ls to the obstacle (the vehicle running ahead). The control change setting section 88 is also supplied with the required deceleration distance LGB from the required deceleration distance correcting section 84, the target yaw rate γt from the target yaw rate computation section 85, the yaw rate deviation Δγ from the yaw rate deviation computation section 86, and the result of determination of whether the vehicle operator is performing an avoidance operation from the avoidance operation determination section 87. If the vehicle 1 cannot avoid the obstacle only by a braking operation and the vehicle 1 is being maneuvered to avoid the obstacle, the vehicle 1 changes to an avoidance travel mode according to the steering operation and the vehicle behavior. In the avoidance travel mode, the control change setting section 88 sets a signal (a signal for improving the turning-round, a signal for improving the stability, or a signal for releasing the avoidance travel mode) to be outputted to each of the vehicle behavior control sections 60, 65, 70, and 75. In addition, in the avoidance travel mode, a signal is outputted to the alarm drive section 89 so that the alarm lamp 55 is maintained in an ON state until the avoidance travel mode is released. That is, the control change setting section 88 is provided as avoidance control means.

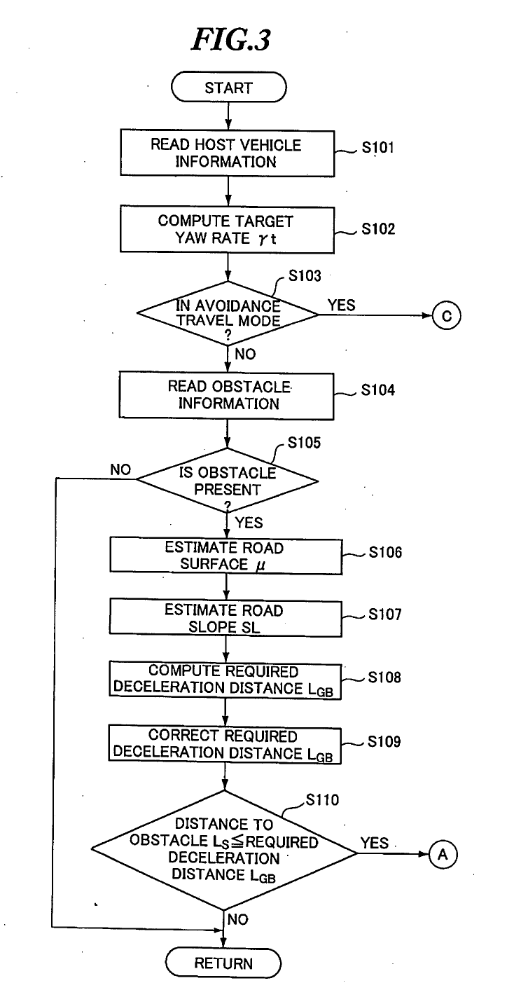

Now, referring to the flowcharts of an avoidance travel control program in FIGS. 3 to 6, a description will be made to the control provided by the avoidance travel control section 80 of the vehicle 1 during an avoidance travel. The avoidance travel control program is executed at preset time intervals. To begin with, in Step (hereinafter simply referred to as “S”) 101, the process reads information on the vehicle and then proceeds to S102, where the target yaw rate γt is computed by Equation (6) mentioned above.

Then, the process proceeds to S103, where it is determined whether the process is already in the avoidance travel mode. If not, the process proceeds to S104, whereas if true, the process proceeds to S125.

Here, a description will be made first to the case where the process is not in the avoidance travel mode and thus proceeds to S104. In S104, the process reads information on obstacles, and then in S105, the process determines whether an obstacle (including a vehicle running ahead) is present.

If it is determined in S105 that no obstacle is present, the process exits the program as it is. On the other hand, if an obstacle is present, the process proceeds from S105 to S106, where the process estimates the roadway friction coefficient μ and then proceeds to S107, where the roadway slope SL is estimated by Equation (2) above.

Thereafter, the process proceeds to S108, where the process computes the required deceleration distance LGB by Equation (4) mentioned above, and then proceeds to S109, where the process provides a correction to the required deceleration distance LGB according to Equation (5) above.

Then, in S110, the process compares the required deceleration distance LGB, which has been finally computed by being provided with the correction, with the distance Ls to the obstacle. If the result of this comparison shows that the distance Ls to the obstacle is greater than the required deceleration distance LGB (Ls>LGB), and it can be determined that only the braking operation by the vehicle 1 is enough to avoid a collision with the obstacle, then the process exits the program as it is.

On the other hand, if it is determined in S110 that the distance Ls to the obstacle is equal to or less than the required deceleration distance LGB (Ls≦LGB) and thus only the braking operation by the vehicle 1 is not enough to avoid a collision with the obstacle, then the process proceeds to S111.

In the procedures of S111 to S118, it is determined whether the vehicle operator is performing an avoidance operation. In S111, it is first determined whether the absolute value of the steering wheel angle θH is equal to or greater than the setting value. If the result of this determination shows that the absolute value of the steering wheel angle θH has not reached the setting value, then the process determines that the vehicle operator is not performing a turning-round operation, and thus that the vehicle operator is not performing an avoidance operation. The process then exits the program as it is.

Conversely, if the absolute value of the steering wheel angle θH is equal to or greater than the setting value, the process proceeds to S112 onward. It is determined in S112 if the absolute value of the steering wheel angular speed (dθH/dt) is equal to or greater than the setting value, and in S113 if the accelerator opening θac is equal to or greater than the setting value. It is also determined in S114 if the engine speed Ne is equal to or greater than the setting value, in S115 if the engine torque Te is equal to or greater than the setting value, and in S116 if the longitudinal acceleration GX is equal to or greater than the setting value. It is further determined in S117 if the traction control is active (ON), and in S118 if the parking brake switch is an ON state. If true in any one of these procedures (if YES), then the process determines that the vehicle operator is performing an avoidance operation, and thus proceeds to S119 to change to the avoidance travel mode.

On the other hand, if not true in all of S112 to S118 (if NO), the process determines that the vehicle operator is not performing an avoidance operation and thus exits the program as it is.

When the process has determined that the vehicle operator is performing an avoidance operation, and thus proceeded to S119 to change to the avoidance travel mode, the direction of front wheel steering in that driving condition is memorized.

Then, in S120, the process determines whether the absolute value of the steering wheel angle θH is greater than the predetermined value, i.e., a steering operation has been already performed. If the absolute value of the steering wheel angle θH is greater than the predetermined value and thus a steering operation has been performed, the process proceeds to S121.

In S121, the absolute value of the target yaw rate γt is compared with the absolute value of the actual yaw rate y to determine the state of the vehicle behavior. If the absolute value of the target yaw rate γt is greater than the absolute value of the actual yaw rate γ (|γt|>|γ|) and thus the vehicle behavior can be considered to have an understeer tendency, the process proceeds to S122. In S122, the process outputs a signal for each of the vehicle behavior control sections 60, 65, 70, and 75 to change the control characteristic to increase the turning-round.

More specifically, a correction is provided to the front and rear drive force distribution control section 60 such that the computed target yaw rate γt (absolute value) used in the front and rear drive force distribution control section 60 is multiplied by a coefficient greater than 1 to make the target yaw rate γt (absolute value) greater than usual. The correction to decrease the clutch torque causes more drive force to be distributed to the rear wheels than to the front wheels, thereby improving the turning-round.

A correction is also provided to the right and left drive force distribution control section 65 such that the computed target yaw rate γt (absolute value) used in the right and left drive force distribution control section 65 is multiplied by a coefficient greater than 1 to make the target yaw rate γt (absolute value) greater than usual. This correction causes more drive force to be distributed to the outer cornering wheels, thereby improving the turning-round.

Furthermore, a correction is provided to the rear wheel steering control section 70 such that the steering wheel angle sensitive gain kδ0 is multiplied by the rear wheel steering angle correction value f1 greater than 1, thereby increasing the absolute value thereof. The correction causes the rear wheels to be steered in opposite phase with the steering wheel angle θH with respect to the normal operation, thereby improving the turning-round. A correction is also provided so that the yaw rate sensitive gain kγ0 is multiplied by the rear wheel steering angle correction value f2 less than 1 and thus made smaller than usual. A small correction is thus provided to the rear wheels in phase with the yaw rate γ, thereby improving the turning-round.

A correction is also provided to the braking force control section 75 such that the computed target yaw rate γt (absolute value) used in the braking force control section 75 is multiplied by a coefficient greater than 1 to make the target yaw rate γt (absolute value) greater than usual, thereby improving the turning-round.

On the other hand, when the result of comparison in S121 between the absolute value of the target yaw rate γt and the absolute value of the actual yaw rate γ shows that the absolute value of the target yaw rate γt is equal to or less than the absolute value of the actual yaw rate γ(|γt|≦|γ⊕) and the vehicle behavior can be considered to have an oversteer tendency, the process proceeds to S123. In S123, the process outputs a signal for each of the vehicle behavior control sections 60, 65, 70, and 75 to change the control characteristic to improve the stability.

More specifically, a correction is provided to the front and rear drive force distribution control section 60 such that the computed target yaw rate γt (absolute value) used in the front and rear drive force distribution control section 60 is multiplied by a coefficient less than 1 to make the target yaw rate γt (absolute value) smaller than usual. The correction causes the clutch torque to be increased so that the drive force is distributed equally between the front and rear wheels, thereby improving the stability.

A correction is also provided to the right and left drive force distribution control section 65 such that the computed target yaw rate γt (absolute value) used in the right and left drive force distribution control section 65 is multiplied by a coefficient less than 1 to make the target yaw rate γt (absolute value) smaller than usual. The correction prevents an increase in the drive force to be distributed to the outer cornering wheels, thereby improving the stability.

A correction is also provided to the rear wheel steering control section 70 such that the steering wheel angle sensitive gain kδ0 is multiplied by the rear wheel steering angle correction value f1 less than 1 to decrease its absolute value. This prevents the rear wheels from being steered in opposite phase with the steering wheel angle θH with respect to the normal operation, thereby improving the stability. A correction is also provided so that the yaw rate sensitive gain kγ0 is multiplied by the rear wheel steering angle correction value f2 greater than 1 and thus made greater than usual. This causes the rear wheels to be more corrected in phase with the yaw rate γ, thereby improving the stability.

A correction is also provided to the braking force control section 75 such that the computed target yaw rate γt (absolute value) used in the braking force control section 75 is multiplied by a coefficient less than 1 to make the target yaw rate γt (absolute value) smaller than usual, thereby improving the stability.

In addition, if the absolute value of the steering wheel angle θH is equal to or less than the predetermined value in S120, then it is expected that a steering operation will be performed afterward to steer around and thereby avoid the obstacle. Thus, the process proceeds to S122, where it outputs a signal for each of the vehicle behavior control sections 60, 65, 70, and 75 to change the control characteristic to increase the turning-round.

In this manner, after the processing in S122 or S123, the process proceeds to S124, whereto inform the vehicle operator of the avoidance travel mode, the process outputs a signal to the alarm drive section 89 to turn ON the alarm lamp 55, and then exits the program.

A description will now be made to the case where the process determines in S103 that it is in the avoidance travel mode, and then proceeds to S125. In S125 after S103, the process determines whether the current avoidance travel mode serves for each of the vehicle behavior control sections 60, 65, 70, and 75 to change the control characteristic to increase the turning-round.

When having determined in S125 that the control characteristic is being changed to increase the turning-round, the process proceeds to S126, where it is determined whether the direction of front wheel steering is reversed, i.e., the current direction of front wheel steering is reversed with respect to the direction of front wheel steering that has been memorized in S119. If not, the process exits the program as it is, whereas if true, the process proceeds to S127. In S127, the process outputs a signal for each of the vehicle behavior control sections 60, 65, 70, and 75, which are now changing to increase the turning-round, to change the control characteristic to improve the stability.

On the other hand, if it has been determined in S125 that the control characteristic is changing to improve the stability, the process proceeds to S128. In S128, it is determined whether the state of the absolute value of the steering wheel angle EH being equal to or less than a predetermined value has continued for a predetermined period of time or more. If not, the process proceeds to S129, where the yaw rate deviation Δγ is computed by Equation (11) above. Then, in S130, the process determines whether the state of the absolute value of the yaw rate deviation Δγ being equal to or less than a predetermined value has continued for a predetermined period of time or more. If not, the process exits the program as it is.

If the condition is satisfied in either S128 or S130, i.e., if the state of the absolute value of the steering wheel angle θH being equal to or less than a predetermined value has continued for a predetermined period of time or more, or if the state of the absolute value of the yaw rate deviation Δγ being equal to or less than a predetermined value has continued for a predetermined period of time or more, the process proceeds to S131. In S131, the process cancels the instruction (releases the avoidance travel mode) for each of the vehicle behavior control sections 60, 65, 70, and 75 to change the control characteristic, and proceeds to S132, where the process cancels the signal outputted to the alarm drive section 89 and then exits the program.

As described above, the embodiment of the present invention is configured to pre-determine an obstacle on the roadway ahead of the vehicle 1, and then take into account roadway information, such as roadway friction coefficients and roadway slopes, and the relative movement between the vehicle 1 and the obstacle. This allows for accurately determining whether the vehicle 1 can avoid the obstacle only by a braking operation.

Suppose that the vehicle 1 cannot avoid the obstacle only by the braking operation of the vehicle 1 and no avoidance operation is being performed for the vehicle 1 to avoid the obstacle. In this case, each of the vehicle behavior control sections 60, 65, 70, and 75 is activated in the avoidance travel mode according to the steering operation being then performed and the vehicle behavior being in an understeer or oversteer state. This allows the vehicle operator to easily operate the vehicle to safely avoid the obstacle.

On the other hand, when the vehicle operator is performing an avoidance operation, each vehicle behavior control section is brought into the avoidance travel mode by adequately reflecting the operation and intention of the vehicle operator. It can be thus ensured that the vehicle operator is prevented from feeling uneasy, and each vehicle behavior controller naturally provides a proper operation to appropriately avoid the obstacle.

Furthermore, during an avoidance travel, greater importance is generally placed on the turning-round in the first half. In the second half after the vehicle has swerved around the obstacle and the steering wheel has been turned backwardly, greater importance is placed on the stability. In the avoidance travel mode, this is precisely determined from the steering operation and a change in the vehicle behavior, so that each of the vehicle behavior control sections 60, 65, 70, and 75 provides necessary control.

In addition, the avoidance travel mode is released with the precise timing when the steering operation by the vehicle operator causes the end of the avoidance travel to be detected or when the stability of the vehicle behavior is detected after the obstacle has been avoided.

Note that the embodiment of the present invention illustrated is an example in which an image captured by a pair of CCD cameras 51R and 51L is processed to detect an obstacle; however, the invention is not limited thereto. For example, it is also possible to employ devices such as monocular cameras, ultrasound radars, or lasers to detect obstacles.

In addition, in the embodiment of the present invention, the vehicle 1 includes four vehicle behavior control sections: the front and rear drive force distribution control section 60, the right and left drive force distribution control section 65, the rear wheels steering control section 70, and the braking force control section 75. The avoidance travel control section 80 outputs a signal to these four sections. However, the present invention is also applicable even to a case where at least one of these vehicle behavior control sections 60, 65, 70, and 75 is controlled by the avoidance travel control section 80. Furthermore, although not explicitly illustrated in this embodiment, it is also possible to employ a front wheel steering control section as a vehicle behavior control section for providing an adequate steering angle correction to the front wheel steering angle according to the running condition of the vehicle.

Furthermore, in the embodiment of the present invention, the parameters (the target yaw rate, the steering wheel angle sensitive gain, or the yaw rate sensitive gain) at the vehicle behavior control sections 60, 65, 70, and 75 are multiplied by a constant greater than 1 to provide a correction to increase the absolute values thereof. To provide a correction to decrease these absolute values, they are multiplied by a constant less than 1. However, the invention is not limited to this method but may also employ any method so long as it can provide a correction.

Furthermore, in the embodiment of the present invention, the front and rear drive force distribution control section 60 employs the target yaw rate as a correction parameter during control; however, the invention is not limited to this control method. In this case, what is required is that the engagement torque of the transfer clutch 21 can be defined so that more drive force is distributed to the rear wheels to increase the turning-round, and the drive force is equally distributed between the front and rear wheels to improve the stability.

Furthermore, in the embodiment of the present invention, the right and left drive force distribution control section 65 also employs the target yaw rate as a correction parameter during control; however, the invention is not limited to this control method. In this case, when the vehicle is determined to have a more enhanced understeer tendency than the reference steering characteristic, the turning-round is increased as follows. That is, a correction is made to the target right and left drive force distribution ratio so that greater drive force is applied to the outer wheels or greater braking force is applied to the inner wheels. On the other hand, the stability is improved as follows when the vehicle is determined to have a more reduced understeer tendency or oversteer tendency than the reference steering characteristic. That is, a correction is made to the target right and left drive force distribution ratio so that greater drive force is applied to the inner wheels or greater braking force is applied to the outer wheels. Furthermore, a mechanism for right and left drive force distribution other than the one according to this embodiment may also be employed. For example, a well-known hydraulic pressure pump motor may also be used to allocate drive force between the right and left wheels.

The embodiment of the present invention illustrated is also an example in which the rear wheels steering control section 70 employs “the opposite phase steering wheel angle+the in-phase yaw rate control rules” as the basic control rules; however, the invention is not limited thereto. For example, it is also possible to employ the well known “yaw rate feedback control rules” or the “front wheel steering angle proportional control rules.” To increase the turning-round, even according to other control rules, the rotational drive angle of the rear wheels is corrected in opposite phase with respect to the front wheels including the amount of in-phase steering being decreased. On the other hand, to improve the stability, the rotational drive angle of the rear wheels is corrected in phase with respect to the front wheels including the amount of opposite-phase steering being decreased.

Furthermore, the braking force control provided by the braking force control section 75 is not limited to the one according to the embodiment of the present invention. When the vehicle is determined to have a more enhanced understeer tendency than the reference steering characteristic, the turning-round is increased as follows. That is, a correction is made to increase the target yaw moment, thereby increasing the braking force to be applied. On the other hand, the stability is improved as follows when the vehicle is determined to have a more reduced understeer tendency or oversteer tendency than the reference steering characteristic. That is, a correction may be made to increase the target yaw moment, thereby increasing the braking force to be applied.

What is claimed is:

1. A vehicle motion control device including:
obstacle recognition means for recognizing an obstacle of the vehicle by detecting information of the obstacle;
vehicle running condition detecting means for detecting running condition of the vehicle;
vehicle behavior control means for controlling a vehicle behavior by varying a turning-round performance of the vehicle;
avoidance control means for controlling the vehicle behavior control means so as to set the vehicle behavior into an obstacle avoidance traveling mode;
avoidance operation detecting means for detecting an avoidance operation of the vehicle against the obstacle;
steering operation detecting means for detecting whether a steering operating mount is equal to or greater than a predetermined value or not; and
vehicle behavior detecting means for detecting the vehicle's understeer state and oversteer state based on the running condition;
wherein the avoidance control means controls the vehicle behavior control means so as to vary the turning-round performance in the obstacle avoidance mode according to vehicle's understeer state and oversteer state when the steering operating mount is equal to or greater than the predetermined value and the avoidance operation is performed.

2. The vehicle motion control device according to claim 1, wherein
the avoidance operation detecting means detects an avoidance operation of the vehicle against the obstacle when at least any one of a steering wheel angle, a actual yaw rate, a lateral acceleration, a skid angle, or a vehicle travel vector exceeds a preset value.
